(19) United States
(12) Patent Application Publication
(10) Pub. No.: US 2006/0133902 A1
(43) Pub. Date: Jun. 22, 2006

(54) Drilling template

(76) Inventor: Harold Gene Brewington, Wynne, AR (US)

Correspondence Address: Harold Brewington, 213 Lawson Ave., Wynne, AR, 72396, US

(21) Appl. No.: 11/016,226

(22) Filed: Dec. 17, 2004

(51) Int. Cl. B23B 47/28

(52) U.S. Cl. 408/115 R

(57) ABSTRACT

An apparatus is used to drill the holes in the overhead area of a door jamb to attach a parallel arm bracket. The apparatus includes a template body that attaches to the overhead area of a door jamb using a magnet or magnets and drill bushings located in the template body in the correct location to drill the holes in the overhead area of the door jamb to attach the parallel arm bracket.

### BACKGROUND OF THE INVENTION

At present drilling the holes in the overhead area of the door jamb to attach the parallel arm bracket is accomplished by using a tape measure to lay out the holes to be drilled.

### Summary of the Invention

My invention is used to drill holes in the overhead area of the door jamb to attach the parallel arm bracket. By using the drilling template that attaches to the overhead area of the door jamb using a magnet or magnets, and drill bushings that are located in the correct position in the template body matching the layout of the holes in the parallel arm bracket.

### BRIEF DESCRIPTION OF THE DRAWING

FIG. 1 shows the front view of the template with drill bushings 2 and magnets 3.

FIG. 2 shows the right end view of the template with a locator stop 4 at the right side of the template body.

### DETAILED DESCRIPTION OF THE INVENTION

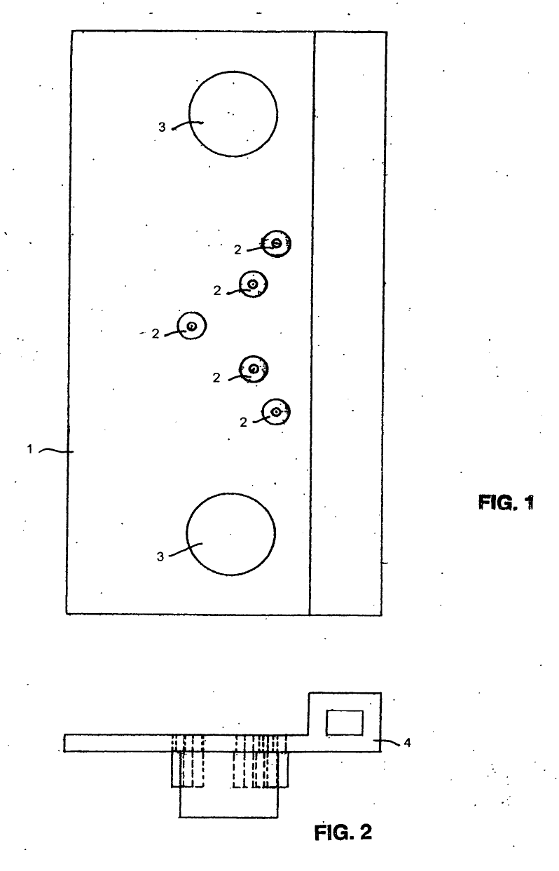

This invention is a drilling template used to drill the holes in the overhead area of a door jamb to install a parallel arm bracket. The drilling template body is generally designated 1 as shown in FIG. 1 and has a locating stop 4 on the right side of the body of the drilling template, as shown in FIG. 2, and generally consists of a magnet 3, or magnets 3, to hold the drilling template in the correct position while drilling the holes in the overhead area of the door jamb and drill bushings 2 in the template body in the correct location to drill the holes in the overhead area of the door jamb to install a parallel arm bracket.

What I claim as my invention is:

1. “a drilling template used for drilling the overhead area of a door jamb for the application of a parallel arm bracket.

2. Referring to the drawing in further detail, the invention designated as shown in FIG. 1 and generally consists of a template body 1 and generally consists of drill bushings 2 and a magnet or magnets 3 as shown in FIG. 1 drawing.”
